(19) United States
(12) Patent Application Publication
(10) Pub. No.: US 2026/0183954 A1
(43) Pub. Date: Jul. 2, 2026

(54) PROXIMITY AND TACTILE SYNERGISTIC PERCEPTION SYSTEM FOR ROBOTIC GRIPPER IN ADAPTIVE GRASPING

(71) Applicant: NANCHANG UNIVERSITY, Nanchang (CN)

(72) Inventors: Pengwen XIONG, Nanchang (CN); Muye HU, Nanchang (CN); Yuxuan HUANG, Nanchang (CN); Yang XIAO, Nanchang (CN); Jun ZOU, Nanchang (CN); Jiangang OUYANG, Nanchang (CN); Changfeng XIA, Nanchang (CN); Jian XIONG, Nanchang (CN); Qian LI, Nanchang (CN); Zhijun GUO, Nanchang (CN)

(73) Assignee: NANCHANG UNIVERSITY, Nanchang (CN)

(21) Appl. No.: 19/435,621

(22) Filed: Dec. 29, 2025

(30) Foreign Application Priority Data
Dec. 30, 2024 (CN) 202411968237.9

(51) Int. Cl. B25J 9/16; B25J 9/00; B25J 13/08; B25J 15/10

(52) U.S. Cl. CPC B25J 9/1669; B25J 9/0009; B25J 13/084; B25J 13/086; B25J 15/10

(57) ABSTRACT

Provided is a proximity and tactile synergistic perception system for robotic gripper in adaptive grasping. The proximity and tactile synergistic perception system includes a perception module, an execution module, and a data transmission and processing module. The perception module includes flexible transparent fingertips, proximity sensor arrays, and multiplexers. The execution module includes a three-fingered robotic gripper and a robotic arm. The data transmission and processing module includes a controller and a host computer.

### CROSS-REFERENCE TO RELATED APPLICATIONS

This application claims priority to the Chinese Patent Application No. 202411968237.9, filed on Dec. 30, 2024, the entire contents of which are incorporated herein by reference.

### TECHNICAL FIELD

The present disclosure relates to the field of robotic sensing technology, in particular to a proximity and tactile synergistic perception system for a robotic gripper in adaptive grasping.

### BACKGROUND

In recent years, active perception technology for robotic grippers has been widely applied in complex manipulation tasks. As a mainstream approach, visual-tactile synergistic perception combines the remote information acquisition capability of vision with the fine contact information perception capability of tactile sensing, which improves the adaptive grasping performance of robotic grippers to a certain extent. However, visual sensing is susceptible to interference from illumination variations, occlusion, and background complexity in complex scenarios, making it difficult to provide stable and reliable prior information. In contrast, the combination of proximity and tactile sensing demonstrates remarkable technical advantages, which enables non-contact perception capability and effectively avoids occlusion issues. Nevertheless, current sensing schemes generally adopt spatially separated proximity and tactile sensing, which leads to temporal and spatial mismatches when fusing information from the two modalities. Moreover, the sensing schemes feature high computational complexity, making it difficult to meet the requirements for high-efficiency operations in dynamic environments, thus limiting the performance of grasping systems. In addition, many existing grasping systems rely on rigid fingers, which are prone to damage fragile, flexible, or irregularly shaped objects, resulting in limitations in applicability.

Therefore, it is desirable to provide a proximity and tactile synergistic perception system for a robotic gripper in adaptive grasping to solve the above technical problems.

### SUMMARY

One or more embodiments of the present disclosure provide a proximity and tactile synergistic perception system for a robotic gripper in adaptive grasping, comprising: a perception module, an execution module, and a data transmission and processing module. The perception module includes flexible transparent fingertips, proximity sensor arrays, and multiplexers; the execution module includes a three-fingered robotic gripper and a robotic arm; the data transmission and processing module includes a controller and a host computer. Each of the flexible transparent fingertips is made of a polyethylene terephthalate glycol-modified (PETG) material with high elasticity and ductility and is prepared by 3D printing, and mimics a human finger to achieve soft grasping of a target object. Each of the proximity sensor arrays consists of three proximity sensors arranged on a printed circuit board (PCB) in an equilateral triangle, and each of the multiplexers is disposed at a center of the proximity sensor array of the equilateral triangle. The proximity sensor arrays feed back proximity information and tactile information, and the proximity information and the tactile information have spatial consistency and are used to achieve adaptive adjustment of a grasping posture and a grasping force of the three-fingered robotic gripper. The proximity sensor arrays are embedded in the flexible transparent fingertips and worn on fingers of the three-fingered robotic gripper, and communicate with the controller using an inter-integrated circuit (IIC) protocol. The controller is connected to the host computer.

In some embodiments, each of the flexible transparent fingertips includes a sealed hollow structure, and a root portion of each of the flexible transparent fingertips is provided with a micro-pneumatic interface; the micro-pneumatic interface is connected to a miniature air pump and an air pressure sensor; and the miniature air pump is disposed at a rear end of the execution module.

In some embodiments, each of the proximity sensors employs an integrated infrared proximity sensing chip.

In some embodiments, the data transmission and processing module implements communication between the controller and the host computer using a universal asynchronous receiver/transmitter (UART) communication protocol, and implements communication between the controller and the execution module using the UART communication protocol.

In another aspect, one or more embodiments of the present disclosure provide an operation method of the proximity and tactile synergistic perception system for the robotic gripper in adaptive grasping described above. The operation method includes: performing system initialization; collecting the proximity information, and adaptively adjusting the grasping posture; collecting the tactile information, and adaptively adjusting the grasping force; and grasping the target object.

In some embodiments, the collecting the proximity information, and adaptively adjusting the grasping posture includes: collecting raw values rᵢⱼ of nine proximity sensors of three groups of proximity sensor arrays, wherein i=0,1,2, representing a group number of each of the three groups of proximity sensor arrays, j=0,1,2, representing a serial number of each of the proximity sensors in each of the three groups of proximity sensor arrays; converting the raw values rᵢⱼ into distances dᵢⱼ to a surface of the target object by the host computer using a pre-trained neural network model; calculating a roll angle αₕᵢ and a pitch angle αᵥᵢ of the three flexible transparent fingertips, respectively, and calculating a shortest distance of the three flexible transparent fingertips with calculation formulas as follows:

$${α}_{h i} = {tan}^{- 1} \frac{\vert {d}_{i 2} - {d}_{i 0} \vert}{x} ,$$

$${α}_{v i} = {tan}^{- 1} \frac{\vert {d}_{i 2} + {d}_{i 0} - 2 {d}_{i 1} \vert}{\sqrt{3} x} ,$$

$${D}_{i} = min \{ {d}_{i 0} , {d}_{i 1} , {d}_{i 2} \} ,$$

wherein αₕᵢ denotes a roll angle of an i-th flexible transparent fingertip, αᵥᵢ denotes a pitch angle of the i-th flexible transparent fingertip, dᵢ₀, dᵢ₁, dᵢ₂ denote distances from the three proximity sensors of the i-th flexible transparent fingertip to the surface of the target object, respectively, x denotes a side length of the proximity sensor array of the equilateral triangle of the i-th flexible transparent fingertip, and Dᵢ denotes a shortest distance from the proximity sensor array of the i-th flexible transparent fingertip to the surface of the target object; with a target of αₕᵢ=αᵥᵢ=0, and D₀=D₁=D₂, adjusting the grasping posture of the three-fingered robotic gripper in time through error feedback control, such that the target object is located at a center of three fingers of the three-fingered robotic gripper, and contact surfaces of the three fingers are parallel to the target object.

In some embodiments, the operation method further includes: before grasping, determining a morphological adaptability of the flexible transparent fingertips based on a morphological feature and a surface roughness of the target object; determining a target stiffness of the flexible transparent fingertips based on the morphological adaptability and category information of the target object; determining a target air pressure of the flexible transparent fingertips based on the target stiffness; and controlling a miniature air pump to fill air into or extract air out of a sealed hollow structure of the flexible transparent fingertips until an air pressure inside the flexible transparent fingertips reach the target air pressure.

In some embodiments, the collecting the tactile information, and adaptively adjusting the grasping force further includes: after the three-fingered robotic gripper equipped with the flexible transparent fingertips contacts the surface of the target object, the proximity sensor arrays indirectly reflecting the tactile information, transmitting the tactile information to the host computer for collation and analysis, and controlling the grasping force within a preset range.

In some embodiments, the collecting the tactile information, and adaptively adjusting the grasping force includes: extracting a target frequency band feature based on a target frequency band of a proximity sampling signal; determining whether the target object slips based on the target frequency band feature; in response to the target object slipping, determining a target grasping force based on a current grasping force and a surface roughness of the target object; and controlling the three-fingered robotic gripper to increase the grasping force to the target grasping force.

In some embodiments, the collecting the tactile information, and adaptively adjusting the grasping force further includes: after the three-fingered robotic gripper increases the grasping force, performing the following iteration: controlling the three-fingered robotic gripper to decrease the grasping force by a preset magnitude; if the target frequency band feature does not satisfy an oscillation condition, entering a next iteration; and if the target frequency band feature satisfies the oscillation condition, controlling the three-fingered robotic gripper to maintain the grasping force, and ending the iteration.

### BRIEF DESCRIPTION OF THE DRAWINGS

The present disclosure is further described by way of exemplary embodiments. These exemplary embodiments are described in detail with reference to the accompanying drawings. These embodiments are not limiting. In the embodiments, the same reference numerals denote the same structures.

FIG. 1 is a schematic diagram illustrating an overall structure of a proximity and tactile synergistic perception system for a robotic gripper in adaptive grasping according to some embodiments of the present disclosure;

FIG. 2 is a schematic diagram illustrating a structure of a perception module of a proximity and tactile synergistic perception system for a robotic gripper in adaptive grasping according to some embodiments of the present disclosure; and

FIG. 3 is a flowchart illustrating an operation method of a proximity and tactile synergistic perception system for a robotic gripper in adaptive grasping according to some embodiments of the present disclosure.

Reference signs in the figures: 1. Flexible transparent fingertip; 11. Sealed hollow structure; 2. Proximity sensor array; 21. Proximity sensor; 3. Multiplexer; 4. Three-fingered robotic gripper; 5. Robotic arm; 6. Controller; 7. Host computer; 8. Micro-pneumatic interface; 9. Miniature air pump; 10. Air pressure sensor.

### DETAILED DESCRIPTION

To more clearly illustrate the objectives, technical solutions, and advantages of the embodiments of the present disclosure, the embodiments of the present disclosure are described in detail below in conjunction with specific embodiments and accompanying drawings. It should be noted that the embodiments and descriptions herein are explanatory only and do not limit the embodiments of the present disclosure in any form.

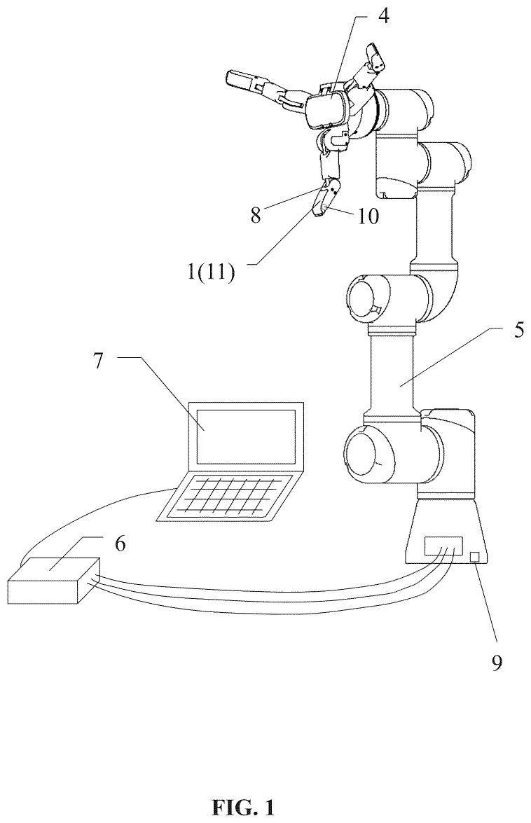

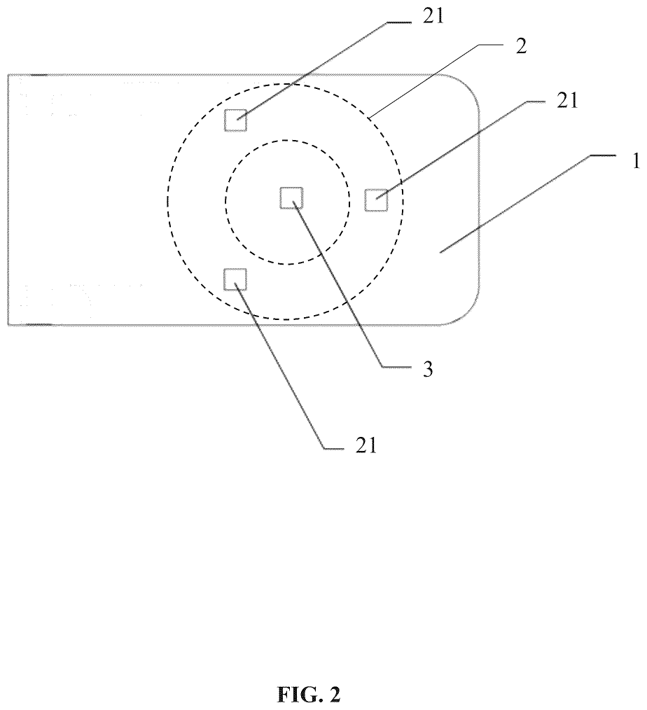

FIG. 1 is a schematic diagram illustrating an overall structure of a proximity and tactile synergistic perception system for a robotic gripper in adaptive grasping according to some embodiments of the present disclosure; and FIG. 2 is a schematic diagram illustrating a structure of a perception module of a proximity and tactile synergistic perception system for a robotic gripper in adaptive grasping according to some embodiments of the present disclosure.

As shown in FIG. 1 and FIG. 2, the embodiments of the present disclosure provide the proximity and tactile synergistic perception system for the robotic gripper in adaptive grasping (hereinafter referred to as the perception system). The perception system includes a perception module, an execution module, and a data transmission and processing module. The perception module includes flexible transparent fingertips 1, proximity sensor arrays 2, and multiplexers 3. The execution module includes a three-fingered robotic gripper 4 and a robotic arm 5. The data transmission and processing module includes a controller 6 and a host computer 7. Each of the flexible transparent fingertips 1 is made of a polyethylene terephthalate glycol-modified (PETG) material with high elasticity and ductility and is prepared by 3D printing, and mimics a human finger to achieve soft grasping of a target object. Each of the proximity sensor arrays 2 consists of three proximity sensors 21 arranged on a printed circuit board (PCB) in an equilateral triangle, and the multiplexer 3 is disposed at a center of the proximity sensor array 2 of the equilateral triangle. The proximity sensor arrays 2 feed back proximity information and tactile information, and the proximity information and the tactile information have spatial consistency and are used to achieve adaptive adjustment of a grasping posture and a grasping force of the three-fingered robotic gripper 4. The proximity sensor arrays 2 are embedded in the flexible transparent fingertips 1 and worn on fingers of the three-fingered robotic gripper 4, and communicate with the controller 6 using an inter-integrated circuit (IIC) protocol. The controller 6 is connected to the host computer 7.

The perception module is configured to implement proximity and tactile synergistic perception.

The flexible transparent fingertip 1 refers to a perception front end configured to touch and grasp the target object.

In some embodiments, the flexible transparent fingertip 1 is detachably disposed at a free end of each finger of the three-fingered robotic gripper 4.

In some embodiments, the flexible transparent fingertip 1 may also be made of other materials with high elasticity, ductility, and transparency (e.g., thermoplastic polyurethane, composite materials, etc.), which not only ensures the information collection effect of the proximity sensor array 2, but also ensures that a surface of the flexible transparent fingertip 1 can deform based on a shape of a contact surface of the target object during grasping, thereby reducing damage to the target object.

The target object refers to an object that needs to be grasped. The target object may be any object. Merely by way of example, the target object may be a regular object, an irregular object, a flexible object, a rigid object, etc.

In some embodiments, the flexible transparent fingertip 1 may also be prepared by other manners. Merely by way of example, the flexible transparent fingertip 1 may be prepared by casting molding, etc.

The proximity sensor array 2 refers to an array consisting of a plurality of proximity sensors 21. In some embodiments, as shown in FIG. 1 and FIG. 2, the PCB is fixedly disposed at an end (i.e., an end away from the target object during grasping) of the flexible transparent fingertip 1 away from a finger pulp, and the proximity sensor array 2 is fixed on the PCB.

In some embodiments, a count of the proximity sensor arrays 2 is determined based on a count of the flexible transparent fingertips 1, and the count of the flexible transparent fingertips 1 is determined based on a count of the fingers of the robotic gripper. Merely by way of example, as shown in FIG. 1, when the three-fingered robotic gripper 4 is used, the perception module includes three groups of proximity sensor arrays 2, and each of the three groups of proximity sensor arrays 2 is disposed in one flexible transparent fingertip 1.

The IIC protocol is a synchronous, serial, multi-master-slave, half-duplex communication protocol. In other embodiments, the proximity sensor array 2 may also be in communication connection to the controller 6 using other protocols.

The proximity sensor 21 is configured to collect the proximity information and the tactile information. In some embodiments, the proximity sensor 21 may be one of a photoelectric proximity sensor, a microwave photoelectric sensor, etc.

The proximity information refers to data regarding a spatial relationship between the flexible transparent fingertips 1 and the surface of the target object obtained by the proximity sensors 21 through non-contact measurement when the flexible transparent fingertips 1 are not in physical contact with the target object. For example, the proximity information may include a distance from each proximity sensor 21 to the surface of the target object, etc.

The tactile information refers to data regarding a contact state between the flexible transparent fingertips 1 and the target object indirectly reflected by each proximity sensor 21 when the flexible transparent fingertips 1 are in physical contact with the target object. For example, the tactile information may include that when a distance between the flexible transparent fingertips 1 and the surface of the target object is less than a distance threshold, the target object contacts the flexible transparent fingertips 1. The distance threshold may be set based on experience. More descriptions regarding how to indirectly obtain the tactile information may be found in descriptions below.

In some embodiments, as shown in FIG. 2, one of the proximity sensor arrays 2 may include three proximity sensors 21 arranged in an equilateral triangle, i.e., distances between the three proximity sensors 21 are equal. In this way, when the flexible transparent fingertip 1 contacts the target object and deforms, a relative positional relationship among the three proximity sensors 21 within the flexible transparent fingertip 1 remain unchanged.

It is worth noting that for a technical solution where a proximity sensor and a tactile sensor are separately arranged to collect the proximity information and the tactile information, respectively, subsequent complex coordinate transformation and alignment are required to achieve spatial registration. However, in the embodiments, the proximity information and the tactile information are collected by the same group of proximity sensor array, and since relative positions of the three proximity sensors 21 remain unchanged when the flexible transparent fingertip 1 deforms, i.e., a spatial coordinate system of the collected proximity information and tactile information does not change, thus the collected proximity information and tactile information inherently have the spatial consistency.

The multiplexer 3 is configured to implement information transfer between the proximity sensor array 2 and the controller 6. In some embodiments, the multiplexer 3 is disposed at a center point of the equilateral triangle arrangement of the proximity sensors 21. In some embodiments, the multiplexer 3 may be in communication connection to the proximity sensor array 2 and the controller 6 via a cable connection, a communication protocol, etc.

The execution module is configured to perform a grasping action.

The three-fingered robotic gripper 4 refers to a robotic gripper with three fingers. The structure of the fingers of the three-fingered robotic gripper 4 is similar to the structure of human fingers.

The robotic arm 5 is configured to carry the three-fingered robotic gripper 4. In some embodiments, one end of the robotic arm 5 is fixed to an external structure (e.g., a fixed base, etc.), and another end of the robotic arm 5 is connected to the three-fingered robotic gripper 4. In some embodiments, an interior of the robotic arm 5 is hollow, so as to accommodate structures such as pipelines.

The data transmission and processing module is configured to transmit and process data and information generated during an operation process of the perception system.

The controller 6 is configured to control a plurality of components of the perception module and the execution module in real time, and process various information and instructions generated during the operation process of the perception system. Merely by way of example, the controller 6 may be at least one of a microcontroller, a programmable controller, etc. In some embodiments, the controller 6 may be in communication connection to other components of the perception system via a cable connection, a communication protocol, etc.

The host computer 7 is configured to process various information and instructions generated during the operation process of the perception system. Merely by way of example, the host computer 7 may be at least one of a mobile phone, a tablet computer, an operation panel, etc. In some embodiments, the host computer 7 implements interaction between a user and other components of the perception system. In some embodiments, the host computer 7 is in communication connection to the controller 6. The user may adjust the operation process (e.g., adjust the grasping posture and the grasping force, etc.) of the perception system via the host computer 7. In some embodiments, the controller 6 and the host computer 7 may be connected via a cable or a communication protocol.

In some embodiments, as shown in FIG. 1, each of the flexible transparent fingertips 1 includes a sealed hollow structure 11, and a root portion of each of the flexible transparent fingertips 1 is provided with a micro-pneumatic interface 8. The micro-pneumatic interface 8 is connected to a miniature air pump 9 and an air pressure sensor 10. The miniature air pump 9 is disposed at a rear end of the execution module.

The sealed hollow structure 11 refers to a sealed cavity inside each of the flexible transparent fingertips 1. In some embodiments, the sealed hollow structure 11 may be filled with air.

The micro-pneumatic interface 8 refers to a physical interface disposed at the root portion of each of the flexible transparent fingertips 1. The root portion refers to an end of each of the flexible transparent fingertips 1 close to a connection position of the three-fingered robotic gripper 4 and the robotic arm 5. In some embodiments, an air pipeline may be inserted into the micro-pneumatic interface 8. One end of the air pipeline is in communication with the sealed hollow structure 11 of each of the flexible transparent fingertip 1, and another end of the air pipeline penetrates through an inner cavity of the finger and a hollow interior structure of the robotic arm 5 to be in communication with the external miniature air pump 9, thereby achieving air filling and extracting.

The miniature air pump 9 is configured to fill air into or extract air out of the sealed hollow structure 11. The rear end refers to an end away from a free end of the three-fingered robotic gripper 4. In some embodiments, the miniature air pump 9 is disposed at a rear end of the robotic arm 5 and is in communication with the air pipeline. In some embodiments, a valve is disposed at an interface between the miniature air pump 9 and the air pipeline and configured to open or cut off air flow.

In some embodiments, when air is filled into or extracted out of the sealed hollow structure 11, an internal pressure intensity of the sealed hollow structure 11 changes, thereby enabling the flexible transparent fingertip 1 to have different deformation capabilities.

The air pressure sensor 10 is configured to monitor a real-time pressure intensity of the sealed hollow structure 11. In some embodiments, the air pressure sensor 10 may be one of a piezoresistive air pressure sensor, a capacitive air pressure sensor, etc. In some embodiments, the air pressure sensor 10 may be disposed in the air pipeline or in the sealed hollow structure 11 of each of the flexible transparent fingertips 1.

In some embodiments of the present disclosure, the sealed hollow structure in combination with a pneumatic device can change the internal pressure intensity of the flexible transparent fingertip, thereby enabling the perception system to have a capability to adjust the stiffness and expansion degree of the three flexible transparent fingertips.

In some embodiments, each of the proximity sensors 21 employs an integrated infrared proximity sensing chip. The integrated infrared proximity sensing chip can actively emit infrared light, and measure a distance between the integrated infrared proximity sensing chip and the target object in a non-contact manner by receiving reflected light reflected by the target object.

In some embodiments, the data transmission and processing module implements communication between the controller 6 and the host computer 7 using a universal asynchronous receiver/transmitter (UART) communication protocol, and implements communication between the controller 6 and the execution module using the UART communication protocol. The UART communication protocol is an asynchronous, serial, full-duplex, and point-to-point communication protocol.

In other embodiments, the data transmission and processing module implements communication between the controller 6 and the host computer 7 using other manners or communication protocols, and implements communication between the controller 6 and the execution module using other manners or communication protocols.

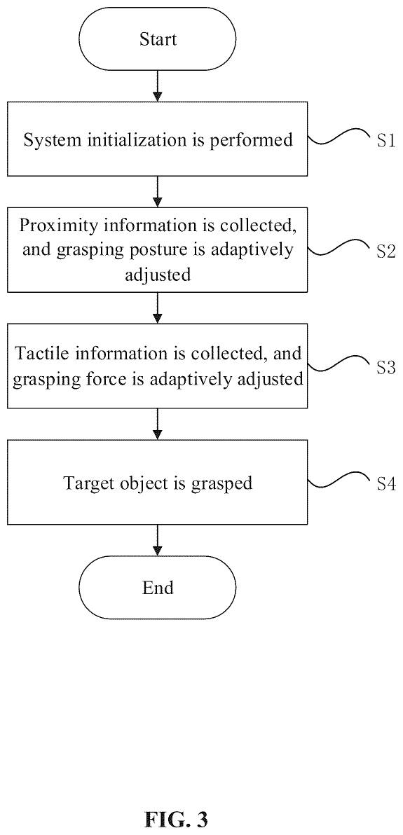

FIG. 3 is a flowchart illustrating an operation method of a proximity and tactile synergistic perception system for a robotic gripper in adaptive grasping according to some embodiments of the present disclosure.

The embodiments of the present disclosure further provide the operation method of the proximity and tactile synergistic perception system for the robotic gripper in adaptive grasping described in the foregoing embodiments. The operation method may be executed by the controller 6 and/or the host computer 7. As shown in FIG. 3, the operation method includes the following operations.

In S1, system initialization is performed.

In some embodiments, after the host computer receives an initialization instruction input by a user, the perception system completes self-check (e.g., loading parameters, determining a posture and a position of three fingers of a three-fingered robotic gripper, etc.).

In S2, proximity information is collected, and a grasping posture is adaptively adjusted.

The grasping posture refers to a posture of the three-fingered robotic gripper when grasping a target object. For example, the grasping posture includes a morphology of each finger, etc. In some embodiments, the proximity sensor arrays may collect the proximity information, and the host computer may analyze the proximity information to enable the controller to adjust the grasping posture of the three-fingered robotic gripper. More descriptions regarding the proximity information may be found in the descriptions of FIG. 1 and FIG. 2.

In S3, tactile information is collected, and a grasping force is adaptively adjusted.

In some embodiments, the host computer may determine whether a shortest distance between the flexible transparent fingertips and the surface of the target object is less than a distance threshold. In response to determining that the distance between the flexible transparent fingertips and the surface of the target object is less than the distance threshold, the host computer feeds back the tactile information indicating that the target object is in contact with the flexible transparent fingertips, or the host computer feeds back the proximity information indicating that the target object is not in contact with the flexible transparent fingertips. The shortest distance between the flexible transparent fingertips and the surface of the target object may be obtained by a pre-trained neural network model by analyzing a light intensity of reflected light received by the proximity sensor arrays. The distance threshold may be set based on experience. More descriptions regarding the tactile information may be found in the descriptions of FIG. 1 and FIG. 2.

The grasping force refers to a force when the three-fingered robotic gripper grasps the target object. For example, the grasping force may be characterized by current and/or torques of driving motors of the three fingers of the three-fingered robotic gripper.

In some embodiments, the host computer may enable the controller to adjust the grasping force of the three-fingered robotic gripper based on the proximity information.

In S4, the target object is grasped.

In some embodiments, the controller controls the three-fingered robotic gripper to grasp the target object based on the determined grasping posture and the determined grasping force.

In some embodiments, the S2 includes the following operations.

In S2.1, raw values rᵢⱼ of nine proximity sensors of the three groups of proximity sensor arrays are collected, wherein i=0,1,2, representing a group number of each of the three groups of proximity sensor arrays, j=0,1,2, representing a serial number of each of the proximity sensors in each of the three groups of proximity sensor arrays; the raw values rᵢⱼ are converted into distances dᵢⱼ to a surface of the target object by the host computer using a pre-trained neural network model. The raw value refers to an initial value collected by the proximity sensor after the perception system completes the self-check. For example, when the proximity sensor is an integrated infrared proximity sensing chip, the raw value may be a received light intensity of reflected light.

In S2.2, a roll angle αₕᵢ and a pitch angle αᵥᵢ of the three flexible transparent fingertips are calculated, respectively, and a shortest distance of the three flexible transparent fingertips is calculated with calculation formulas as follows:

$${α}_{h i} = {tan}^{- 1} \frac{\vert {d}_{i 2} - {d}_{i 0} \vert}{x} , \qquad ( 1 )$$

$${α}_{v i} = {tan}^{- 1} \frac{\vert {d}_{i 2} + {d}_{i 0} - 2 {d}_{i 1} \vert}{\sqrt{3} x} , \qquad ( 2 )$$

$${D}_{i} = min \{ {d}_{i 0} , {d}_{i 1} , {d}_{i 2} \} . \qquad ( 3 )$$

Where αₕᵢ denotes a roll angle of an i-th flexible transparent fingertip, αᵥᵢ denotes a pitch angle of the i-th flexible transparent fingertip, dᵢ₀, dᵢ₁, dᵢ₂ denote distances from the three proximity sensors of the i-th flexible transparent fingertip to the surface of the target object, respectively, x denotes a side length of the proximity sensor array of the equilateral triangle of the i-th flexible transparent fingertip, and Dᵢ denotes a shortest distance from the proximity sensor array of the i-th flexible transparent fingertip to the surface of the target object.

The roll angle refers to an angle between a line perpendicular to a pointing direction of the flexible transparent fingertip and a horizontal line. The pitch angle refers to an angle between a line parallel to the pointing direction of the flexible transparent fingertip and the horizontal line. The side length of the proximity sensor array may be understood as a straight-line distance between any two proximity sensors of the proximity sensor array.

In S2.3, with the target of αₕᵢ=αᵥᵢ=0, and D₀=D₁=D₂, the grasping posture of the three-fingered robotic gripper is adjusted in time through error feedback control, such that the target object is located at a center of three fingers of the three-fingered robotic gripper, and contact surfaces of the three fingers are parallel to the target object.

The error feedback control may be understood as follows: during adjustment of the grasping posture, the host computer continuously determines actual values of the roll angles, the pitch angles, and the shortest distances from the three groups of proximity sensor arrays of the flexible transparent fingertips to the surface of the target object, and gradually adjusts the grasping posture of the three-fingered robotic gripper according to an error between the actual values and the target.

The target object being located at the center of the three fingers of the three-fingered robotic gripper may be understood as follows: the target object is at a center of connecting lines of the three flexible transparent fingertips. The contact surfaces of the three fingers being parallel to the target object may be understood as follows: a plane where the three flexible transparent fingertips are located is parallel to the contact surfaces of the target object.

In some embodiments, the controller may also control the three fingers of the three-fingered robotic gripper, such that the target object is within a first preset range of the center of the three fingers of the three-fingered robotic gripper, and an angle between the plane where the three fingers are located and the contact surfaces of the target object is within a second preset range. The first preset range and the second preset range may be determined based on experience.

In some embodiments, the S3 further includes: after the three-fingered robotic gripper equipped with the three flexible transparent fingertips contacts the surface of the target object, the proximity sensor arrays indirectly reflecting the tactile information, transmitting the tactile information to the host computer for collation and analysis, and controlling the grasping force within a preset range. The preset range may be set based on actual requirements. The principle of feeding back the tactile information is similar to the descriptions of the S3 in FIG. 3.

In some embodiments, the host computer may analyze the tactile information to determine the grasping force that neither damages the target object nor causes slippage of the target object. More descriptions regarding how to determine the grasping force may be found in related descriptions below.

In some embodiments, the operation method further includes: before grasping, determining a morphological adaptability of the flexible transparent fingertips based on a morphological feature and a surface roughness of the target object; determining a target stiffness of the flexible transparent fingertips based on the morphological adaptability and category information of the target object; determining a target air pressure of the flexible transparent fingertips based on the target stiffness; and controlling a miniature air pump to fill air into or extract air out of a sealed hollow structure of the flexible transparent fingertips until an air pressure inside the flexible transparent fingertips reach the target air pressure.

The morphological feature refers to a feature related to a shape, a structure, a contour, etc., of the target object. In some embodiments, the morphological feature may include a curvature change rate and an irregularity degree of the target object.

In some embodiments, the host computer may determine the curvature change rate and the irregularity degree of the target object in various ways.

In some embodiments, the perception module further includes a depth camera in communication connection to the host computer. The depth camera may be disposed at the center of the three fingers of the three-fingered robotic gripper or any other feasible position. In some embodiments, the host computer may obtain a depth image of the target object collected by the depth camera, and convert the depth image into three-dimensional point cloud data of the target object.

For example, for a data point n in the three-dimensional point cloud data, the host computer may select k data points closest to the data point n (i.e., select a k-neighborhood), and perform principal component analysis (PCA) on the data point n and the k data points to obtain three eigenvalues λ₁, λ₂, λ₃. The three eigenvalues may represent a dispersion degree of k+1 data points within the k-neighborhood in directions of corresponding principal components. Then, the curvature change rate of the k-neighborhood may be determined using the following formula:

$${σ}_{n} = \frac{min \{ {λ}_{1} , {λ}_{2} , {λ}_{3} \}}{{λ}_{1} + {λ}_{2} + {λ}_{3}} . \qquad ( 4 )$$

Where σₙ denotes the curvature change rate of the data point n in the three-dimensional point cloud data in the k-neighborhood thereof. A value of k is set based on actual requirements.

According to the above manner, the host computer may determine curvature change rates of a plurality of data points in the three-dimensional point cloud data in corresponding k-neighborhoods thereof, and use a standard deviation of the curvature change rates of the k-neighborhoods of the plurality of data points as the curvature change rate of the target object.

As another example, the host computer may select a plurality of data points corresponding to a local region (e.g., a region that the flexible transparent fingertip may contact) on the target object, fit an ideal plane using a preset algorithm (e.g., a random sample consensus (RANSAC) algorithm, least squares, etc.), determine distances from the plurality of data points in the local region to the ideal plane, and use a standard deviation of the distances as the irregularity degree of the target object. The ideal plane refers to a plane that makes a curvature of the local region continuous.

The surface roughness is used to measure a roughness degree of the surface of the target object. In some embodiments, the perception module further includes an optical camera in communication connection to the host computer. The optical camera may be disposed at the center of the three fingers of the three-fingered robotic gripper or any other feasible position. In some embodiments, the host computer may acquire an optical image of the target object collected by the optical camera, determine a surface friction coefficient of the target object through a visual analysis technology (e.g., gray-level co-occurrence matrix (GLCM) texture analysis), and use the surface friction coefficient as the surface roughness.

The morphological adaptability characterizes an adaptation degree between a stiffness of the flexible transparent fingertip and the target object. A value of the morphological adaptability is negatively correlated with the stiffness of the flexible transparent fingertip.

In some embodiments, the host computer may perform normalization processing on the curvature change rate, the irregularity degree, and the surface roughness of the target object, then perform weighted summation, and use a result as the morphological adaptability. The normalization processing may be Min-Max normalization, etc. Weights may be set based on experience. A weight of the surface roughness may be a negative number.

The category information characterizes a category to which the target object belongs. For example, the target object is a glass cup or an apple. In some embodiments, the category information may be determined based on user input.

The target stiffness refers to a hardness required for the surface of the flexible transparent fingertip to match the target object. In some embodiments, the host computer may construct a feature vector based on the morphological adaptability and the category information of the target object, determine a reference feature vector satisfying a preset requirement by querying a vector database; and determine a reference stiffness corresponding to the reference feature vector as the target stiffness. The preset requirement may be a minimum vector distance between the feature vector and the reference feature vector, a highest vector similarity, etc.

The vector database includes a plurality of reference feature vectors and corresponding reference stiffnesses. In some embodiments, the vector database may be constructed based on historical data. For example, the host computer may select a plurality of historical morphological adaptabilities and a plurality of pieces of historical category information to construct corresponding reference feature vectors. For a plurality of historical grasps corresponding to each of the plurality of reference feature vectors, a historical stiffness with an optimal grasping effect is used as the reference stiffness corresponding to each of the plurality of reference feature vectors. The optimal grasping effect may include minimum deformation of a surface of a historical target object or a minimum count of slippage of the historical target object during grasping.

The target air pressure refers to an air pressure intensity required in the sealed hollow structure of the flexible transparent fingertip to achieve the target stiffness of the flexible transparent fingertip. In some embodiments, the host computer may determine the target air pressure by querying a first preset table based on the target stiffness. The first preset table may include a correspondence between a plurality of target stiffnesses and target air pressures. The first preset table may be set based on experience.

In some embodiments, the host computer may control, via the controller, the miniature air pump to fill air into or extract air out of the sealed hollow structure of the flexible transparent fingertip. An air pressure sensor may continuously monitor the real-time air pressure of the sealed hollow structure. In response to determining that the real-time air pressure reaches the target air pressure, a valve of an air pipeline is closed, and air stops being filled or extracted.

In some embodiments of the present disclosure, by progressively confirming the morphological feature, the surface roughness, the morphological adaptability, and the category information of the target object, and matching the optimal fingertip stiffness, the wrapping performance and grasping stability of the three-fingered robotic gripper for objects of different shapes and materials can be enhanced.

In some embodiments, the host computer may extract a target frequency band feature based on a target frequency band of a proximity sampling signal; determine whether of the target object slips based on the target frequency band feature; in response to the target object slipping, determine a target grasping force based on a current grasping force and a surface roughness of the target object; and control the three-fingered robotic gripper to increase the grasping force to the target grasping force.

The proximity sampling signal refers to an electrical signal collected by the proximity sensors. The target frequency band refers to a signal within a preset frequency range separated from the proximity sampling signal. The preset frequency range may be set based on actual requirements, such as 50 Hz-500 Hz. In some embodiments, the host computer may extract the target frequency band from the proximity sampling signal.

The target frequency band feature refers to an energy spectral density (ESD) of the proximity sampling signal within the target frequency band. The ESD is used to characterize an energy intensity distribution of a signal in a frequency domain. In some embodiments, the host computer may perform Fast Fourier Transform (FFT) on the target frequency band to convert a time-domain signal into a frequency-domain signal, determine an energy intensity distribution (i.e., the ESD) of the frequency-domain signal, and then determine the target frequency band feature.

In some embodiments, the host computer may sum a plurality of energy values within the target frequency band to obtain an energy intensity of the target frequency band. In response to determining that the energy intensity of the target frequency band is greater than a preset intensity threshold, the host computer determines that the target object slips and the current grasping force needs to be increased. Otherwise, the host computer determines that the target object does not slip, and the three-fingered robotic gripper may continue to grasp the target object with the current grasping force. The preset intensity threshold may be set based on experience.

The current grasping force refers to a grasping force currently used by the three-fingered robotic gripper for grasping the target object. In some embodiments, the host computer may determine the current grasping force based on current and/or torques of driving motors of the three fingers.

The target grasping force refers to a grasping force required for the three-fingered robotic gripper to prevent the target object from slipping. In some embodiments, the host computer may determine the target grasping force by querying a second preset table based on the current grasping force and the surface roughness of the target object. The second preset table may include a correspondence between a plurality of current grasping forces, surface roughnesses, and target grasping forces. The second preset table may be set based on experience.

In some embodiments, the host computer may increase the current and/or the torques of the driving motors of the three fingers via the controller, thereby increasing the current grasping force to the target grasping force.

In some embodiments of the present disclosure, when the target object generates a slight relative displacement (i.e., the target object slips) on the surface of the flexible transparent fingertip, friction at a contact interface between the target object and the flexible transparent fingertip causes reflected light to generate high-frequency fluctuations. Accordingly, whether the target object slips can be determined by monitoring energy in a high-frequency band. When the target object slips, an anti-slip control strategy can be triggered quickly, effectively preventing a risk of the target object accidentally slipping during the grasping process.

In some embodiments, after the three-fingered robotic gripper increases the grasping force, the following iteration is performed: controlling the three-fingered robotic gripper to decrease the grasping force by a preset magnitude; if the target frequency band feature does not satisfy an oscillation condition, entering a next iteration; and if the target frequency band feature satisfies the oscillation condition, controlling the three-fingered robotic gripper to maintain the grasping force, and ending the iteration. The preset magnitude may be set based on experience.

The oscillation condition refers to a condition for determining whether to enter the next iteration to decrease the grasping force. In some embodiments, the oscillation condition may be that an energy intensity of a reacquired target frequency band is greater than the preset intensity threshold after the grasping force is decreased. The preset intensity threshold may be set based on experience.

In some embodiments of the present disclosure, by progressively decreasing the grasping force after confirming that the target object has no slippage tendency, the three-fingered robotic gripper can be ensured to grasp the target object with a minimum grasping force that does not cause the target object to slip, thereby minimizing the risk of damage to the target object due to an excessive grasping force.

According to the perception system designed in embodiments of the present disclosure, by embedding the proximity sensor arrays into the flexible transparent fingertips, a proximity and tactile synergistic perception framework with spatial consistency can be established. Before and after contacting the target object, the proximity information and the tactile information can be collected at the same spatial location, which effectively reduces information alignment errors, significantly improves spatiotemporal consistency and fusion efficiency of perception, enables more comprehensive characterization of multi-dimensional characteristics of the target object, and accordingly adaptively adjusts the grasping posture and the grasping force to achieve high-precision and high-robustness grasping in dynamic environments.

The proximity sensor array of the perception system is arranged in an equilateral triangle. Positions of the three proximity sensors are relatively fixed and simple, which can simplify the calculation process of information processing and improve the real-time performance of robot perception.

The perception system prepares the flexible transparent fingertips using the PETG material, such that the flexible transparent fingertips have high elasticity and high ductility, and can mimic the human fingers to achieve soft grasping, thereby effectively improving grasping flexibility, reducing the risk of damage to the target object, and thus enhancing adaptability of the grasping process.

Obviously, those skilled in the art can make various modifications and variations to the embodiments of the present disclosure without departing from the spirit and scope of embodiments of the present disclosure. Thus, if the modifications and variations of the embodiments of the present disclosure fall within the scope of the claims of the present disclosure and their equivalents, the present disclosure is also intended to cover the modifications and variations.

What is claimed is:

1. A proximity and tactile synergistic perception system for a robotic gripper in adaptive grasping, comprising: a perception module, an execution module, and a data transmission and processing module; wherein
the perception module includes flexible transparent fingertips, proximity sensor arrays, and multiplexers;
the execution module includes a three-fingered robotic gripper and a robotic arm;
the data transmission and processing module includes a controller and a host computer;
each of the flexible transparent fingertips is made of a polyethylene terephthalate glycol-modified (PETG) material with high elasticity and ductility and is prepared by 3D printing, and mimics a human finger to achieve soft grasping of a target object;
each of the proximity sensor arrays consists of three proximity sensors arranged on a printed circuit board (PCB) in an equilateral triangle, and each of the multiplexers is disposed at a center of the proximity sensor array of the equilateral triangle;
the proximity sensor arrays feed back proximity information and tactile information, and the proximity information and the tactile information have spatial consistency and are used to achieve adaptive adjustment of a grasping posture and a grasping force of the three-fingered robotic gripper;
the proximity sensor arrays are embedded in the flexible transparent fingertips and worn on fingers of the three-fingered robotic gripper, and communicate with the controller using an inter-integrated circuit (IIC) protocol; and
the controller is connected to the host computer.

2. The proximity and tactile synergistic perception system according to claim 1, wherein each of the flexible transparent fingertips includes a sealed hollow structure, and a root portion of each of the flexible transparent fingertips is provided with a micro-pneumatic interface; the micro-pneumatic interface is connected to a miniature air pump and an air pressure sensor; and the miniature air pump is disposed at a rear end of the execution module.

3. The proximity and tactile synergistic perception system according to claim 1, wherein
each of the proximity sensors employs an integrated infrared proximity sensing chip.

4. The proximity and tactile synergistic perception system according to claim 1, wherein
the data transmission and processing module implements communication between the controller and the host computer using a universal asynchronous receiver/transmitter (UART) communication protocol, and implements communication between the controller and the execution module using the UART communication protocol.

5. An operation method of the proximity and tactile synergistic perception system for the robotic gripper in adaptive grasping according to claim 1, the operation method comprising:
performing system initialization;
collecting the proximity information, and adaptively adjusting the grasping posture;
collecting the tactile information, and adaptively adjusting the grasping force; and
grasping the target object.

6. The operation method according to claim 5, wherein the collecting the proximity information, and adaptively adjusting the grasping posture includes:
collecting raw values rᵢⱼ of nine proximity sensors of three groups of proximity sensor arrays, wherein i=0,1,2, representing a group number of each of the three groups of proximity sensor arrays, j=0,1,2, representing a serial number of each of the proximity sensors in each of the three groups of proximity sensor arrays; converting the raw values rᵢⱼ into distances dᵢⱼ to a surface of the target object by the host computer using a pre-trained neural network model;
calculating a roll angle αₕᵢ and a pitch angle αᵥᵢ of three flexible transparent fingertips, respectively, and calculating a shortest distance of the three flexible transparent fingertips with calculation formulas as follows:
$${α}_{h i} = {tan}^{- 1} \frac{\vert {d}_{i 2} - {d}_{i 0} \vert}{x} ,$$
$${α}_{v i} = {tan}^{- 1} \frac{\vert {d}_{i 2} + {d}_{i 0} - 2 {d}_{i 1} \vert}{\sqrt{3} x} ,$$
$${D}_{i} = min \{ {d}_{i 0} , {d}_{i 1} , {d}_{i 2} \} ,$$
wherein αₕᵢ denotes a roll angle of an i-th flexible transparent fingertip, αᵥᵢ denotes a pitch angle of the i-th flexible transparent fingertip, dᵢ₀, dᵢ₁, dᵢ₂ denote distances from the three proximity sensors of the i-th flexible transparent fingertip to the surface of the target object, respectively, x denotes a side length of the proximity sensor array of the equilateral triangle of the i-th flexible transparent fingertip, and Dᵢ denotes a shortest distance from the proximity sensor array of the i-th flexible transparent fingertip to the surface of the target object;
with a target of αₕᵢ=αᵥᵢ=0, and D₀=D₁=D₂, adjusting the grasping posture of the three-fingered robotic gripper in time through error feedback control, such that the target object is located at a center of three fingers of the three-fingered robotic gripper, and contact surfaces of the three fingers are parallel to the target object.

7. The operation method according to claim 5, further comprising:
before grasping, determining a morphological adaptability of the flexible transparent fingertips based on a morphological feature and a surface roughness of the target object;
determining a target stiffness of the flexible transparent fingertips based on the morphological adaptability and category information of the target object;
determining a target air pressure of the flexible transparent fingertips based on the target stiffness; and
controlling a miniature air pump to fill air into or extract air out of a sealed hollow structure of the flexible transparent fingertips until an air pressure inside the flexible transparent fingertips reach the target air pressure.

8. The operation method according to claim 5, wherein the collecting the tactile information, and adaptively adjusting the grasping force further includes:
after the three-fingered robotic gripper equipped with the flexible transparent fingertips contacts a surface of the target object, the proximity sensor arrays indirectly reflecting the tactile information, transmitting the tactile information to the host computer for collation and analysis, and controlling the grasping force within a preset range.

9. The operation method according to claim 8, wherein the collecting the tactile information, and adaptively adjusting the grasping force includes:
extracting a target frequency band feature based on a target frequency band of a proximity sampling signal;
determining whether the target object slips based on the target frequency band feature;
in response to the target object slipping, determining a target grasping force based on a current grasping force and a surface roughness of the target object; and
controlling the three-fingered robotic gripper to increase the grasping force to the target grasping force.

10. The operation method according to claim 9, wherein the collecting the tactile information, and adaptively adjusting the grasping force further includes:
after the three-fingered robotic gripper increases the grasping force, performing the following iteration: controlling the three-fingered robotic gripper to decrease the grasping force by a preset magnitude; if the target frequency band feature does not satisfy an oscillation condition, entering a next iteration; and if the target frequency band feature satisfies the oscillation condition, controlling the three-fingered robotic gripper to maintain the grasping force, and ending the iteration.
